(19) United States
(12) Patent Application Publication
(10) Pub. No.: US 2009/0197788 A1
(43) Pub. Date: Aug. 6, 2009

(54) RezOlex curling iron clean

(75) Inventor: Linda Sue Apple, Paoli, IN (US)

Correspondence Address: Linda Sue Apple, PO Box 241, Paoli, IN, 47454, US

(73) Assignee: Linda Apple, Paoli, IN (US)

(21) Appl. No.: 12/001,453

(22) Filed: Feb. 5, 2008

(51) Int. Cl. C11D 3/30

(52) U.S. Cl. 510/238; 510/245

(57) ABSTRACT

A non-caustic chemical composition for cleaning surfaces of heat encrusted curling irons, clothes irons of metal, ceramic stovetops, fiberglass bath tubs, shower, sinks, boats, resin furniture, porcelain, and plastic is provided in the form of foam, and liquid sprays. A chemical composition consist of three active ingreadieances 12% diethylene glycol monobutyl ether and sodium carbonate and/or potassium carbonate anhydrous 7%, potassium carbonate preferred, in an aerosol cleaner formulation of monoethanolamine 5%, and Isobutane 5% comprises chemical composition to be applied to said surfaces in aqueous solution. A chemical composition consisting in the form of foam cleaner is much more preferred over scraping curling irons with razor blades, steel wool, comet, alcohol, and trying to soak in water, which runs the irons. The cleaning composition in the form of liquid in a trigger sprays, works well on flat surfaces. A chemical composition in the form of aerosol spray can with pressurized valves sprays a fine mist of foam, which adheres to vertical walls, curved surfaces, allowing cleaner to remain on surface for a period of time, shake, spray, wait, wipe with clean water, with the time period of 10 minutes to 2 hours makes cleaning time more time efficient.

### CROSS-REFERENCE TO RELATED APPLICATION

U.S.A. Patent Reference

Ser. No. 874,857/Jun. 5, 2001.

Ser. No. 10747452/Dec. 29, 2003,

A chemical composition of a new matter in reference to application No. 89232 1993-07-09 A Low Temperature Non-caustic Oven Cleaner composition a prior art.

A chemical composition consisting of three active ingredients that combines with our natural resources, the monoethanolamine can be replaced by equal amount and weight of diethanolamine, which is not as violital as MEH, diethylene glycol monobutyl ether, and sodium carbonate and/or potassium carbonate salts. A chemical composition in reference to application No. 12001453 as a new matter consisting of monoethanolamine 5% and diethylene glycol monobutyl ether 11%, sodium carbonate and/or potassium carbonate anhydrous 6% preferred. A chemical composition consisting of cleaning solution for cleaning curling irons in the form of a liquid trigger spray for flat surfaces, or a pressurized valve in aerosol spray foam with in a fine mist, which adheres to the vertical walls to remove debris from fiberglass showers, tubs, sinks with oil, soap scum, lime, mold, mildew, boats, tile, ceramic stovetops, hard plastic, resin furniture, porcelain, and metal barrels of curling irons encrusted with hair sprays gels, shake the can, spray, wait, wipe with clean water, makes cleaning much more time efficient.

### STATEMENT REGARDING FEDERALLY SPONSORED RESEARCH DEVELOPMENT

“Not applicable”

### REFERENCES TO SEQUENCE LISTING, A TABLE OR COMPUTER PROGRAM LISTING COMPACT DISK APPENDIX

“Not applicable”

### BACKGROUND OF THE INVENTION

A chemical composition in a cleaning solution consist of the three active ingredients of 40% to 100% of a solvent monoethanolamine 1% to 12% by weight, up to 60% diethanolamine can replace monoethanolamine with equivalent weight and percentage. 2% to 20% diethylene glycol monobutyl ether around 1% to 15% which aids in penetration, adhesion and foam control, sodium carbonate and/or potassium carbonate salts, potassium carbonate anhydrous preferred 1% to 10% range. A chemical composition is in a suitable embodiment of the invention, which relates to aqueous cleaning composition capable of removing soiled residue from different surfaces. Application No. 12001453 A curling iron cleaner, that has much more cleaning power than what is available, with the stay-ability in the form of aerosol spray with a mist of foam that can adhere to the curved surfaces of the curling iron. A chemical composition in the form of foam a cleaner is much more preferred over scraping curling irons with razor blades, steel wool, comet, alcohol, and trying to soak in water, which ruins the irons. The cleaning composition in the form of a liquid in a trigger sprays mist that will work well on flat surfaces. A chemical composition comes in the form of aerosol spray with a pressurized valve in a fine mist of foam, which adheres to the vertical walls of fiberglass showers, tubs, sinks with oil, and soap scum, mold, mildew, boats, tile, ceramic stovetops, hard plastic, resin furniture, porcelain, and metal barrels of curling irons encrusted with hair sprays gels. A chemical composition that cleans in 10 minutes to 2 hours, shake the can, spray, wait, wipe with clean water, makes cleaning much more time efficient.

### BRIEF SUMMARY OF THE INVENTION

A chemical composition for a cleaning solution which is time efficient for cleaning surfaces of heat encrusted curling irons, clothes irons of metal, ceramic stovetops, fiberglass bath tubs, shower, sinks, boats, resin furniture, porcelain, and plastic is provided in the form of foam, and liquid spray with time period of 10 minutes to 2 hours, compared to a chemical composition of some curling iron cleaner has trouble with the time it takes to work and in a liquid form that does not stay on the curved surface long enough to soften the residue. A chemical composition for a curling iron cleaner with much more cleaning power and is time efficient, with the aerosol foam that can adheres to the curved surface of the curling irons round structure. The problems with some ceramic stovetops cleaners and fiberglass cleaners that come in a paste form and have to be rubbed in leaving a black residue on hands and on the cloth. A chemical composition consisting of materials in the form of foam is much more preferred over scraping curling irons with razor blades, steel wool, comet, alcohol, and trying to soak in water, which runs the irons. A chemical composition in the form of liquid in a trigger sprays in a fine mist will work well on flat surfaces. A chemical composition in the form of aerosol spray which comes in a fine mist of foam, which adheres to the vertical walls of the fiberglass showers, tubs, sinks, with oil, soap scum, mold, mildew, boats, tile, ceramic stovetops, hard plastic, resin furniture, porcelain, and metal barrels of curling irons encrusted with hair sprays and gels. A chemical composition consists of three active ingredients monoethanolamine, diethylene glycol monobutyl ether and sodium carbonate and/or potassium carbonate, into a cleaning solution.

### BRIEF DESCRIPTION OF THE SEVERAL VIEWS OF THE DRAWING

“Not applicable”

### DETAILED DESCRIPTION OF THE INVENTION

A chemical composition for cleaning curling irons in a suitable embodiment of the invention in which the amine combines with our natural resources, the components consists of 1% to 12% by weight preferred range 2.5 to 8% monoethanolamine, of an amine component consisting of from 40% to 100% and 0% to 60% diethanolamine preferred which is not as violital as MEH the 2% to 20% diethylene, glycol monobutyl ether, 2% to 12% of the carbonate salts, in which the sodium carbonate and/or potassium carbonate comprises 1% to 12% potassium carbonate anhydrous.

A chemical composition consisting of and from 1% to 10% of sodium carbonate and/or potassium carbonate anhydrous preferred.

A chemical composition for cleaning which is time efficient for cleaning surfaces for heat encrusted curling irons, clothes irons of metal, ceramic stovetops, fiberglass bath tubs, shower, sinks, boats, resin furniture, porcelain, and plastic is provided in the form of a foam, an liquid with time period of 10 minutes to 2 hours.

A chemical composition of some known curling iron cleaner takes to long to work in a liquid trigger spray that does not stay on the curved surface long enough to soften the residue.

A chemical composition consist of a formulation for cleaning curling irons in a solution that has much more cleaning power and is time efficient with the aerosol foam that can adheres of the curved surface of the curling irons round structure.

A chemical composition consist of a cleaner for cleaning ceramic stovetops, cleaners and fiberglass cleaners, some come in a paste form and have to be rubbed in leaving a black residue on hands and on the cloth is not time efficient. A chemical composition consisting of a form of foam is much more preferred over scraping curling irons with razor blades, steel wool, comet, alcohol, and trying to soak in water, which runs the irons.

A chemical composition consists of three active ingreadieances diethylene glycol monobutyl ether, in an aerosol cleaner formulation of monoethanolamine,

[symbol]

### EXAMPLE 1

fiberglass bath and shower scrubbed with bleach, lava soap, and toilet bowel cleaner, with no results.

A chemical composition of a formulation of aerosol is applied for 10 minutes to 2 hours with excellent results.

### EXAMPLE 2

Curling iron encrusted with baked on hair spray, gel, conditioner, was scrubbed with alcohol, soft scrub, scraped with razor blades and wire scrubber. This formulation of aerosol is left on 10 to 20 minutes with excellent results.

### EXAMPLE 3

Resin furniture left out side in the elements with mold, mildew, and grime. This formulation was left on for 2 hours, the results were 85% to 98% of residue removed.

FORMULATION
Aerosol spray

| | |
|---|---|
| Monoethanolamine | 5.0% |
| Diethylene Monobutyl Ether | 11.0% to 20% |
| Isobutane propellant A-31 | 5% to 15% |
| Potassium carbonates (anhydrous | 6% to 10% |
| Sodium N-Lauroyl Scarcosinate (30%) | 1.0% |
| Laponite/xanathan gum/vegeenT (27%) | 3.0% |
| Paraffin Emulsion | 1.0% |
| Surfanctant in total should be 5. Percentage | 1.0% |
| (1.0% to 10.%) | |
| TritonCF-54 | .02 |
| Fragrance Irish Spring (10% to 30%) | 1% to 1.2% |
| Distilled | 57% to 98% |

The trigger spray formula is the same forluma without isobutane

1. What I claimed as my invention RezOLex Curling Iron Cleaner I claim as my idea and use of an invention as a new matter method the chemicals combines with our natural resources, in the embodiment of three active ingredients with 40% to 100% monoethanolamine, 0% to 60% diethanolamine can be replace monoethanolamine that is equivalent weight and percentage, 1% to 12% of an amine component, 2% to 20% diethylene glycol monobutyl ether, with a range 1% to 15% aids in penetration, adhesion and foam control, 1% to 10% sodium carbonate and/or potassium carbonate salts, 1% to 10% propellant in a cleaning solution to remove debris from curling irons, fiberglass showers, tubs, sinks with oil and soap scum, lime, mold, mildew boats, tile, ceramic stovetops, and hard plastic, (resin furniture), hairsprays, gels, shake the can spray, wait, wipe with clean water.

2-27. (canceled)

28. A chemical composition according to claim 1 in which monoethanolamine consist of 1% to 12% of an amine component in an aqueous cleaning composition comprising of 1% to 8% monoethanolamine and of 3% to 15% diethylene glycol monobutyl ether and 2% to 8% of carbonate salt the carbonate salt is potassium carbonate anhydrous preferred.

29. A chemical composition according to claim 2 monoethanolamine 5%, diethylene glycol monobutyl ether 5% to 15% and 7% potassium carbonate anhydrous, 90% to 98% of the cleaning solution comprising by weight from 1% to 12% of amine component containing 40% to 100% monethanolamie and 0% to 60% of diethanolamine can be used which is not as volatile as MEH.

30. A chemical composition according to claim 3 2% to 20% of diethylene glycol monobutyl ether, 1% to 10% of sodium carbonate and/or potassium carbonate anhydrous in an aerosol cleaner formulation which consist of 5% of isobutene n-butane, propane and mixtures with 95% of cleaning composition 2.5% to 8% monoethanolamine 8% to 12% diethylene glycol monobutyl ether 2% to 8% of sodium carbonate and/or potassium carbonate anhydrous.

31. A method according to claim 4 of a chemical composition when applied, by aerosol spray with a pressurized valve as a aerosol foam or liquid spray, brushed on, applied with foam applicator, wiped on, splashed on, which is time efficient just shake, spray, wait, wipe with clean water after the solution is permitted to remain on the surface for sufficient time to dissolve and decompose composition of residue. The chemical composition for cleaning curling irons, ceramic stovetops with food encrusted, bonded on by charring with high temperatures and fiberglass which appears to be more pours' that adheres to the vertical walls and curved surfaces cleaning by lifting the debris up into the foam.

32. According to claim 31 a thicking agent xanthan gum/laponite in the amount in an aqueous solution in the range of 0.5% preferable 0.8% in a aqueous premix and mixtures thereof. A composition containing about 3% magnesium aluminum silicate is used as an ingredient formulating the cleansing composition of this invention. For a thickener concentration of 0.8% the 3% premix in amount of 27% of the entire-aqueous composition must be used combinations of thickeners in small amounts such as beeswax or paraffin emulsions or powders may be added to the composition 0.1% to 5.0% by weight preferably 0.% to 2% by weight.

33. According to claim 32 A surfactants should be compatible up to 5% of an aqueous composition containing minor amounts of anionic and or non-ionic should be compatible surface active agents which will cause the solution to spread evenly over the surface to maintain desired level of foaming the preferred surfactant is a sulphuric ester sodium N-lauroyl sulphate small amounts of wetting agents, chelating agents and other solvents, and corrosion inhibitors and fragrances, with other additives.
